(19) United States
(12) Patent Application Publication
(10) Pub. No.: US 2019/0277066 A1
(43) Pub. Date: Sep. 12, 2019

(54) DOOR LOCK CONTROL SYSTEM AND DOOR LOCK APPARATUS

(71) Applicants: KABUSHIKI KAISHA TOSHIBA, Tokyo (JP); TOSHIBA ELECTRONIC DEVICES & STORAGE CORPORATION, Tokyo (JP)

(72) Inventors: Kai SASADATE, Kawasaki Kanagawa (JP); Masaki JONO, Kawasaki Kanagawa (JP); Hiroaki SUGITA, Fuchu Tokyo (JP); Tetsuro OISHI, Yokohama Kanagawa (JP); Minoru YAGI, Yokohama Kanagawa (JP)

(21) Appl. No.: 16/120,074

(22) Filed: Aug. 31, 2018

(30) Foreign Application Priority Data
Mar. 9, 2018 (JP) 2018-042822

(51) Int. Cl. E05B 77/48; G07C 9/00

(52) U.S. Cl. CPC E05B 77/48; G07C 9/00182; G07C 9/00817; G07C 2209/64; G07C 2009/00769; G07C 2009/00841; G07C 2009/00825; G07C 2009/00206

(57) ABSTRACT

A door lock control system includes a first device including a first transmitter, a first receiver, and a first controller configured to measure first signal strengths of radio signals received from a plurality of surrounding devices by the first receiver, and control the first transmitter to transmit the measured first signal strengths to a second device. The system further includes the second device including a second receiver and a second controller configured to measure second signal strengths of radio signals received from a plurality of surrounding devices by the second receiver, control the second receiver to receive the first signal strengths from the first device, compare the first signal strengths with the second signal strengths, and control a door lock based on the comparison of the first and the second signal strengths.

### CROSS-REFERENCE TO RELATED APPLICATIONS

This application is based upon and claims the benefit of priority from Japanese Patent Application No. 2018-042822, filed Mar. 9, 2018, the entire contents of which are incorporated herein by reference.

### FIELD

Embodiments described herein relate generally to a door lock control system and a door lock apparatus.

### BACKGROUND

A door lock control system is known in which an in-vehicle device mounted on a moving unit such as a car locks and unlocks a door by authenticating a specific electronic key possessed by a user. As the door lock control system, there is a system in which a mutual distance from the in-vehicle device to the electronic key is determined based on radio wave intensity of a response signal from the electronic key and the door can be locked and unlocked in a case where the mutual distance is equal to or less than a predetermined distance.

However, in this door lock control system, even if a radio wave is emitted from a point more distant than a predetermined distance, when the radio wave is re-transmitted via a relay device or the like, there is a possibility that the door is erroneously locked and unlocked.

### DESCRIPTION OF THE DRAWINGS

FIG. 1 is a diagram for explaining an arrangement example of a door lock control system.

FIG. 2 is a block diagram illustrating a configuration of an in-vehicle device.

FIG. 3 is a block diagram illustrating a configuration of an electronic key.

FIG. 4 is a diagram illustrating radio wave condition in a case where the distance between the in-vehicle device and the electronic key is 1 meter.

FIG. 5 is a diagram illustrating radio wave condition in a case where the distance between the in-vehicle device and the electronic key is 20 meters.

FIG. 6 is a diagram illustrating an operation example of the door lock control system.

FIG. 7 is a flowchart for explaining determination processing in detail.

FIG. 8 is a block diagram illustrating a configuration of an electronic key according to a modification example.

### DETAILED DESCRIPTION

Embodiments provide a door lock control system and a door lock apparatus that can perform door lock control more accurately according to a distance between devices.

In general, according to an embodiment, a door lock control system comprises a first device comprising a first transmitter, a first receiver, and a first controller configured to measure first signal strengths of radio signals received from a plurality of surrounding devices by the first receiver, and control the first transmitter to transmit the measured first signal strengths to a second device, and the second device including a second receiver, and a second controller configured to measure second signal strengths of radio signals received from a plurality of surrounding devices by the second receiver, control the second receiver to receive the first signal strengths from the first device, compare the first signal strengths with the second signal strengths, and control a door lock based on the comparison of the first and the second signal strengths.

Hereinafter, embodiments of the present disclosure will be described with reference to the drawings.

### One Embodiment

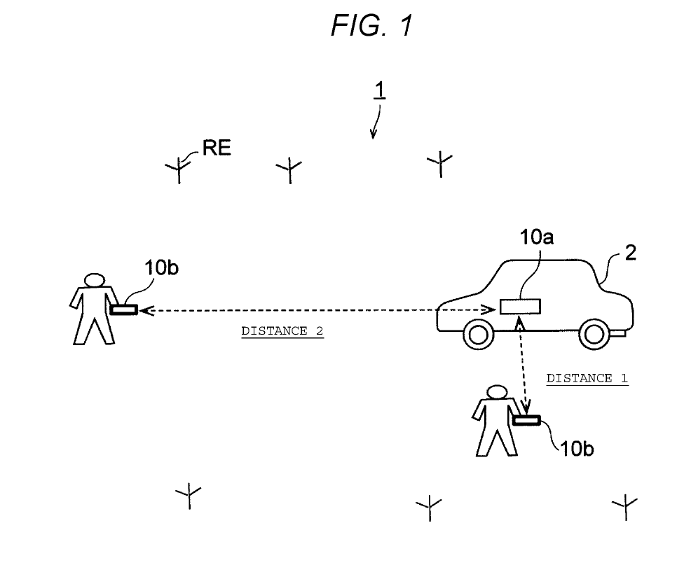

FIG. 1 is a diagram for explaining an arrangement example of a door lock control system 1 according to an embodiment. As illustrated in FIG. 1, the door lock control system 1 according to the present embodiment includes an in-vehicle device 10a and an electronic key 10b capable of performing wireless communication with each other. In FIG. 1, in addition to the door lock control system 1, a car 2 as, for example, a moving unit on which the in-vehicle device 10a is mounted and a plurality of devices RE performing short range communication are illustrated. The plurality of short range communication devices RE are low energy devices such as Bluetooth (registered trademark) device, for example. Here, the in-vehicle device 10a may be another moving unit such as a train, an airplane, or the like. The electronic key 10b is also one of the devices that can perform communication at a short distance, similar to the short range communication device RE.

The in-vehicle device 10a can measure a radio wave condition of the electronic key 10b held by a user and the plurality of short range communication devices RE in the vicinity of the in-vehicle device 10a within a measurable range. With this, whether to lock or unlock the door of the car 2 is controlled, according to similarity between radio wave conditions of the plurality of devices RE measured by the in-vehicle device 10a and the radio wave condition of the plurality of devices RE measured by the electronic key 10b. A detailed configuration of the in-vehicle device 10a will be described later.

The electronic key 10b is a device having a function of measuring radio wave conditions of the plurality of devices RE. The electronic key 10b is, for example, a device carried by a driver (user) of the car 2 as the moving unit, and the radio wave conditions of the plurality of devices RE measured by the electronic key 10b change according to the distance from the in-vehicle device 10a of the car 2. For example, the radio wave conditions of a plurality of devices RE measured by the electronic key 10b at Distance 1 is different from the radio wave conditions of the plurality of devices RE measured by the electronic key 10b at Distance 2. Distance 1 is, for example, 1 meter and Distance 2 is, for example, 20 meters.

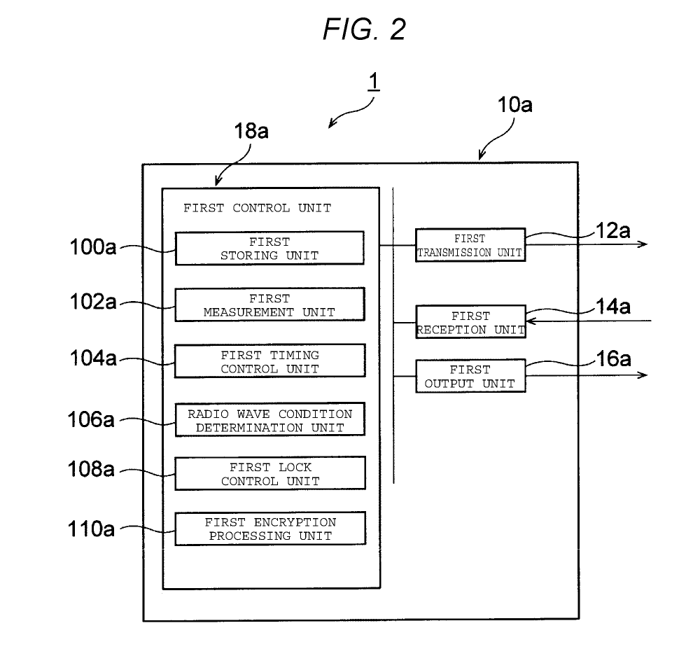

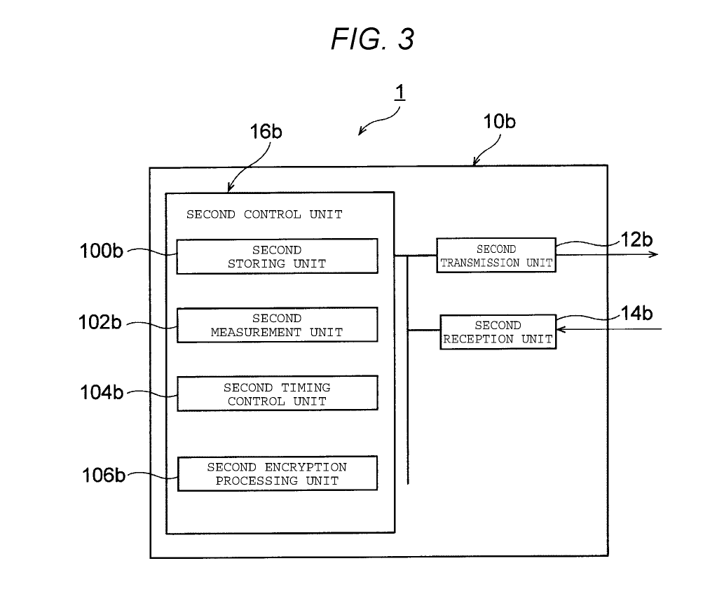

Here, a detailed configuration of the in-vehicle device 10a and the electronic key 10b will be described with reference to FIGS. 2 and 3. FIG. 2 is a block diagram illustrating a detailed configuration of the in-vehicle device 10a of the door lock control system 1 according to the present embodiment. FIG. 3 is a block diagram illustrating a detailed configuration of the electronic key 10b of the door lock control system 1 according to the present embodiment. The “a” is attached to the configuration related to the in-vehicle device 10a, and “b” is attached to the configuration related to the electronic key 10b to distinguish the configurations.

As illustrated in FIG. 2, the in-vehicle device 10a is a device capable of wireless communication with the electronic key 10b, and includes a first transmission unit 12a (e.g., a transmitter circuit), a first reception unit 14a (e.g., a receiver circuit), a first output unit 16a, and a first control unit 18a (e.g., a controller circuit). The first control unit 18a includes a first storing unit 100a, a first measurement unit 102a, a first timing control unit 104a, a radio wave condition determination unit 106a, a first lock control unit 108a, and a first encryption processing unit 110a.

As illustrated in FIG. 3, the electronic key 10b includes a second transmission unit 12b (e.g., a transmitter circuit), a second reception unit 14b (e.g., a receiver circuit), and a second control unit 16b (e.g., a controller circuit). The second control unit 16b includes a second storing unit 100b, a second measurement unit 102b, a second timing control unit 104b, and a second encryption processing unit 106b.

As illustrated in FIG. 1 and FIG. 2, the first transmission unit 12a of device 10a includes an antenna which is attached to, for example, a roof portion of the car 2. The first transmission unit 12a transmits a response request signal or the like to the outside the car or into the car using a radio wave having a long wavelength of 125 KHz or the like.

The first receiver 14a includes an antenna and is attached to, for example, the roof portion of the car 2. The first reception unit 14a receives a response signal or the like transmitted using radio waves of a high frequency band, for example, 315 MHz and the like from the electronic key 10b.

The first output unit 16a outputs a lock signal or an unlock signal to a lock mechanism of the car 2. The lock signal is a signal for locking the door and the unlock signal is a signal for unlocking the door.

The first control unit 18a comprises a processor that reads a program from the first storing unit 100a and executes the program so as to implement a processing unit corresponding to each program. Here, the term “processor” means a circuit, for example, a central processing unit (CPU).

The first storing unit 100a is implemented by a semiconductor memory device such as a random access memory (RAM), a flash memory, a hard disk, or the like. The first storing unit 100a stores programs to be executed by the first control unit 18a and various control data.

The first measurement unit 102a measures a radio wave condition. The first measurement unit 102a measures radio wave intensity from a predetermined device to be measured from the position of the first measurement unit 102a as the radio wave condition. For example, the first measurement unit 102a measures radio wave intensity of radio waves emitted from a device performing short range communication, for example, Bluetooth (registered trademark) low energy device.

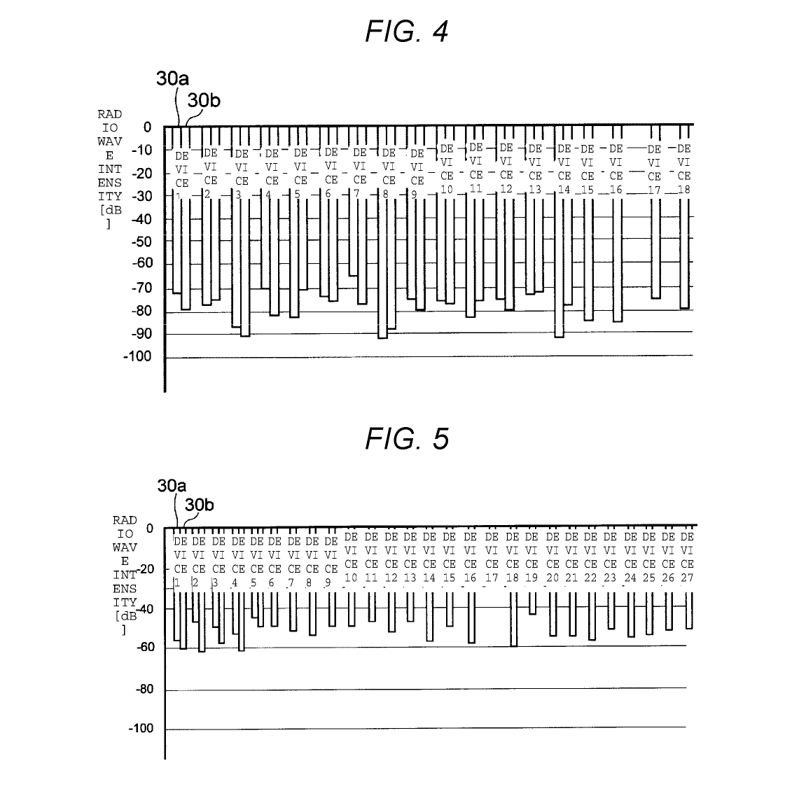

FIG. 4 is a diagram illustrating radio wave conditions in a case where the distance between the in-vehicle device 10a and the electronic key 10b is 1 meter. The horizontal axis represents each device emitting radio waves, and the vertical axis represents radio wave intensity. A left side bar 30a of each pair of a pair of bars for each device corresponds to radio waves measured by the first measurement unit 102a of the in-vehicle device 10a and a bar 30b on the right side of each pair corresponds to radio waves measured by the second measurement unit 102b of the electronic key 10b described later, for each respective device. The first measurement unit 102a acquires the radio wave conditions of sixteen devices among Device 1 to Device 18. Measured signal intensities of fourteen devices (Device 1 to Device 14) of the sixteen devices match that of the devices measured by the second measurement unit 102b. As can be seen from the figure, when the in-vehicle device 10a and the electronic key 10b are close to each other, for example, within 5 meters, the similarity between radio wave conditions acquired by the in-vehicle device 10a (left side bars) and the electronic key 10b (right side bars for each device) is high.

FIG. 5 is a diagram illustrating radio wave conditions in a case where the distance between the in-vehicle device 10a and the electronic key 10b is 20 meters. Pairs of bars along the horizontal axis represent signals from each device emitting radio waves, and the vertical axis represents radio wave intensity for those signals. The bar 30a on the left side of each pair corresponds to radio waves measured by the first measurement unit 102a of the in-vehicle device 10a and the bar 30b on the right side of each pair corresponds to radio waves measured by the second measurement unit 102b of the electronic key 10b. The first measurement unit 102a acquires the radio wave conditions of sixteen devices among Device 1 to Device 27, and regarding the radio wave conditions, five devices of sixteen devices (Device 1 to Device 5) match the devices measured by the second measurement unit 102b. As can be seen from the figure, when the distance between the in-vehicle device 10a and the electronic key 10b is, for example, more than ten meters or more, the similarity between the radio wave conditions acquired by the in-vehicle device 10a and the electronic key 10b is low.

As illustrated in FIG. 2, the first timing control unit 104a synchronizes the timing at which the electronic key 10b measures the radio wave condition and the timing at which measurement by the first measurement unit 102a is performed. More specifically, the first timing control unit 104a transmits a measurement start signal including information on the time for performing one or more measurements to the electronic key 10b by the first transmission unit 12a.

The radio wave condition determination unit 106a compares the radio wave condition measured by the first measurement unit 102a with the radio wave condition transmitted from the electronic key 10b and determines whether or not the similarity is high. For example, the radio wave condition determination unit 106a, determines whether or not the similarity is high according to the number of matching devices that output predetermined radio wave intensity by using the information on the radio wave condition measured by the first measurement unit 102a and the information on the radio wave condition transmitted from the electronic key 10b.

The radio wave condition determination unit 106a may determine whether the similarity is high according to a matching ratio of the devices that output the predetermined radio wave intensity. As illustrated in FIG. 4, for example, in a case where two thirds or more devices, among the devices (Device 1 to Device 18) whose radio wave intensities measured by the first measurement unit 102a are equal to or greater than a predetermined value, match devices (Device 1 to Device 14) measured by the second measurement unit 102b of the electronic key 10b, it is determined that the similarity is high. On the other hand, as illustrated in FIG. 5, in a case where the matching devices (Device 1 to Device 5) among the devices (Device 1 to Device 27) whose radio wave intensities measured by the first measurement unit 102a are equal to or greater than a predetermined value are, for example, less than two thirds of the devices, it is determined that the similarity is low. As such, the radio wave condition determination unit 106a determines whether or not the similarity is high according to the number of matching devices that output the predetermined radio wave intensity, using the mutual radio wave condition information. In the meantime, a criterion for determining the similarity between the radio wave conditions is not necessary to be limited to the matters described above, and it is possible to set the similarity criterion according to the environment in which this system is placed, such as transmission radio wave intensity and reception sensitivity of the in-vehicle device 10a, the electronic key 10b, and the short range communication device RE, the distance between the devices, and the like.

The first lock control unit 108a controls whether to lock or unlock according to the similarity between the radio wave condition measured by the first measurement unit 102a and the radio wave condition transmitted from the electronic key 10b. That is, the first lock control unit 108a controls whether to lock or unlock the door of the car 2, based on the determination of the radio wave condition determination unit 106a. For example, the first lock control unit 108a outputs an unlock signal to the lock mechanism of the car 2 in a case where the radio wave condition determination unit 106a determines that the similarity is high.

On the other hand, in a case where the similarity between the radio wave condition measured by the first measurement unit 102a and the radio wave condition transmitted from the electronic key 10b is low, the first lock control unit 108a outputs a lock signal to the lock mechanism for locking the door to the car 2. For example, the first lock control unit 108a outputs the lock signal to the lock mechanism of the car 2 in a case where the radio wave condition determination unit 106a determines that the similarity is low.

The first encryption processing unit 110a encrypts the first authentication code and decrypts the encrypted second authentication code included in the reception signal. The first encryption processing unit 110a performs authentication processing with the electronic key 10b. For example, in a case where the decrypted second authentication code matches the second authentication code stored in advance in the first storing unit 100a, the first encryption processing unit 110a authenticates the electronic key 10b as a communication partner.

As illustrated in FIG. 3, the second transmission unit 12b includes an antenna and transmits a response signal to the in-vehicle device 10a using radio waves of a high frequency band such as 315 MHz, for example. The second reception unit 14b includes an antenna and receives, for example, a radio wave having a long wavelength of 125 KHz or the like.

The second control unit 16b has a structure equivalent to that of the first control unit 18a and comprises a processor that reads a program from the second storing unit 100b and executes the program so as to implement a processing unit corresponding to each program. The second storing unit 100b is implemented by a semiconductor memory element such as a flash memory or the like. The second storing unit 100b stores programs to be executed by the second control unit 16b and various control data.

The second measurement unit 102b has a structure equivalent to that of the first measurement unit 102a, and measures radio wave condition. The second measurement unit 102b measures the radio wave intensity from a predetermined device to be measured from the position of the second device 10b as the radio wave condition. For example, the second measurement unit 102b measures radio wave intensity of the radio wave emitted from the device performing short range communication.

The second timing control unit 104b performs control to synchronize the timing of measuring the radio wave condition by the in-vehicle device 10 and the timing of measuring the radio wave condition by the second measurement unit 102b. More specifically, the second timing control unit 104b causes the second measurement unit 102b to measure the radio wave condition, based on a measurement start signal including information on the time at which measurement is performed transmitted from the first timing control unit 104a.

The second encryption processing unit 106b has the same configuration as the first encryption processing unit 110a, and decrypts the first authentication code and encrypts the second authentication code. The second encryption processing unit 106b performs authentication processing with the in-vehicle device 10a. For example, in a case where the decrypted first authentication code matches the first authentication code stored in advance in the second storing unit 100b, the second encryption processing unit 106b authenticates the in-vehicle device 10a as a communication partner. The in-vehicle device 10a according to the present embodiment corresponds to the first device, and the electronic key 10b according to the present embodiment corresponds to the second device. Also, the in-vehicle device 10a according to the present embodiment corresponds to a door lock apparatus. Furthermore, although the in-vehicle device 10a according to the present embodiment, that is, the first device is described as a device mounted on a vehicle, for example, as a moving unit, the present disclosure is not limited to the moving unit. For example, it may be a door lock control device (system) fixed at a predetermined place having a door lock function, for example, like a home delivery post.

Matters as described are the description of the configuration of the door lock control system 1 according to the present embodiment. Next, an operation example of the door lock control system 1 will be described.

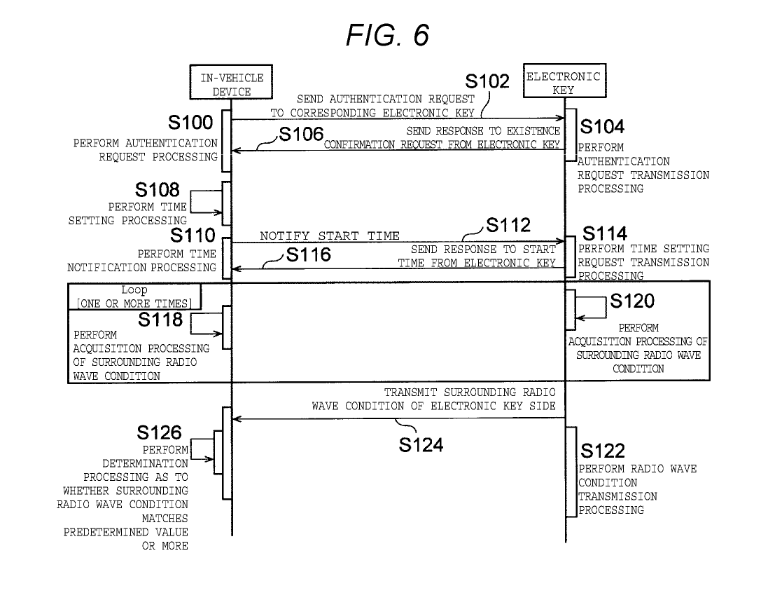

FIG. 6 is a diagram for explaining an operation example of the door lock control system 1. As illustrated in FIG. 6, the first encryption processing unit 110a of the in-vehicle device 10a generates an authentication request signal including the encrypted first authentication code (Step S100). Subsequently, the first encryption processing unit 110a outputs the authentication request signal to the electronic key 10b (Step S102).

The second encryption processing unit 106b of the electronic key 10b decrypts the first authentication code included in the authentication request signal and collates the decrypted first authentication code with the first authentication code stored in advance in the second storing unit 100b (Step S104). Subsequently, in a case where the first authentication code stored in the second storing unit 100b matches the first authentication code included in the authentication request signal, the second encryption processing unit 106b transmits a response signal including the encrypted second authentication code to the in-vehicle device 10a (Step S106).

Next, the first encryption processing unit 110a of the in-vehicle device 10a decrypts the encrypted second authentication code included in the response signal, and authenticates the electronic key 10b as a communication partner when the decrypted second authentication code matches the second authentication code stored in the first storing unit 100a. Subsequently, the first timing control unit 104a performs time setting processing for synchronizing the timing of measuring the radio wave condition in the electronic key 10b and the timing of measuring by the first measurement unit 102a (Step S108). Next, the first timing control unit 104a generates a measurement start signal including the measurement start time set by the time setting processing (Step S110), and transmits the measurement start signal to the electronic key 10b (Step S112).

Next, the second timing control unit 104b of the electronic key 10b sets the measurement start time included in the measurement start signal in the second storing unit 100b (Step S114) and transmits a response signal including information indicating that the measurement start time is set to the first timing control unit 104a of the in-vehicle device 10a (Step S116).

Next, the first measurement unit 102a of the in-vehicle device 10a measures the radio wave intensity of radio waves emitted from the device performing short range communication at the set measurement start time (Step S118). Similarly, the second measurement unit 102b of the electronic key 10b measures radio wave intensities of radio waves emitted by the device performing short range communication at the set measurement start time (Step S120). Subsequently, the second measurement unit 102b generates a radio wave condition signal including information of measured radio wave intensity (Step S122), and transmits the radio wave condition signal to the radio wave condition determination unit 106a of the in-vehicle device 10a (Step S124).

Next, the radio wave condition determination unit 106a compares the radio wave condition measured by the first measurement unit 102a with the radio wave condition transmitted from the electronic key 10b, and determines whether or not the similarity is high (Step S126).

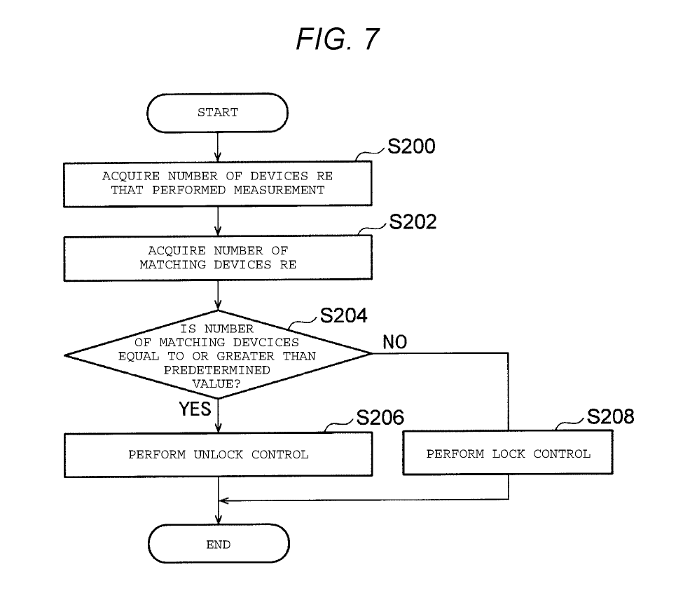

FIG. 7 is a flowchart for explaining the determination processing in Step S126 in detail. As illustrated in FIG. 7, the radio wave condition determination unit 106a acquires the number of devices of a plurality of devices RE outputting signals with predetermined radio wave intensity, using the information of radio wave conditions measured by the first measurement unit 102a (Step S200).

Next, the radio wave condition determination unit 106a compares the radio wave condition measured by the first measurement unit 102a with the radio wave condition transmitted from the electronic key 10b and acquires the number of matching devices between the devices RE detected by the first measurement unit 102a and the devices RE detected on the side of the electronic key 10b (Step S202). Subsequently, the radio wave condition determination unit 106a determines whether a ratio of the number of matching devices to the number of the devices RE detected by the first measurement unit 102a is equal to or greater than a predetermined value, for example, two thirds or more (Step S204).

In a case where it is determined that the ratio of the number of matching devices is equal to or greater than the predetermined value, for example, two thirds or more (YES in Step S204), the radio wave condition determination unit 106a determines whether the in-vehicle device 10a and the electronic key 10 are located within a predetermined distance, for example, within 5 meters. Then, the first lock control unit 108a performs unlock control (Step S206). That is, the first lock control unit 108a outputs an unlock signal for unlocking the door to the lock mechanism of the car 2.

On the other hand, in a case where it is determined that the ratio of the number of matching devices is less than a predetermined value, for example, two thirds (NO in Step S204), the radio wave condition determination unit 106a determines that the in-vehicle device 10a and the electronic key 10 are not located within the predetermined distance, for example, within 5 meters. Then, the first lock control unit 108a performs lock control (Step S208). That is, the first lock control unit 108a outputs a lock signal for locking the door to the lock mechanism of the car 2. As such, the radio wave condition determination unit 106a determines the ratio of the number of matching devices between the devices RE detected by the first measurement unit 102a and the devices RE detected by the electronic key 10 to the total quantity number of the devices RE detected by the first measurement unit 102a is equal to or greater than a predetermined value, for example, two thirds or more. If the ratio is equal to or greater than the predetermined value, the first lock control unit 108a outputs the unlock signal for unlocking the door to the lock mechanism of the car 2, and if the ratio is less than the predetermined value, the first lock control unit 108a outputs the lock signal for locking the door to the lock mechanism of the car 2.

As such, according to the present embodiment, the first lock control unit 108a controls whether to lock or unlock the door according to the similarity between the radio wave condition measured by the first measurement unit 102a and the radio wave condition transmitted from the electronic key 10b. With this, if the distance between the in-vehicle device 10a and the electronic key 10b is shortened so that the similarity of the radio wave condition becomes higher than the predetermined value, it is possible to unlock the door. On the other hand, if the distance between the in-vehicle device 10a and the electronic key 10b is lengthened so that the similarity of the radio wave condition becomes lower than the predetermined value, it is possible to lock the door. As such, since it is controlled whether to lock or unlock the door according to the similarity in the radio wave condition between the in-vehicle device 10a and the electronic key 10b, it is possible to control locking or unlocking of the door in accordance with the distance between the in-vehicle device 10a and the electronic key 10b.

### Modification Example

A modification example is different from an embodiment in that the radio wave condition determination unit 106a and the first lock control unit 108a are provided on the electronic key 10b side.

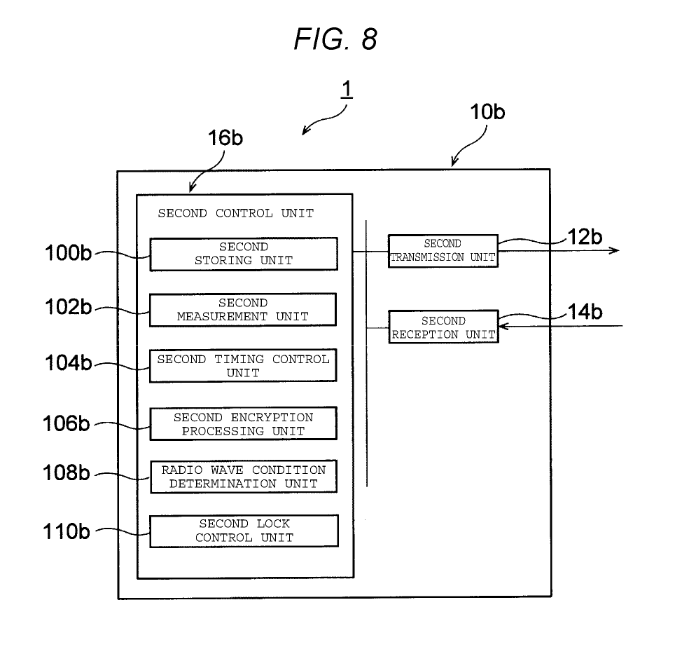

FIG. 8 is a block diagram illustrating a configuration of an electronic key 10b according to a modification example of the embodiment. As illustrated in FIG. 8, the electronic key 10b is different from the embodiment in that the electronic key 10b further includes a radio wave condition determination unit 108b and a second lock control unit 110b.

The radio wave condition determination unit 108b has the same configuration as the radio wave condition determination unit 106a. That is, the radio wave condition determination unit 108b compares the radio wave condition measured by the second measurement unit 102b with the radio wave condition transmitted from the in-vehicle device 10a and determines whether or not the similarity is high.

The second lock control unit 110b has the same configuration as the first lock control unit 108a. That is, the second lock control unit 110b controls whether to lock or unlock the door according to the similarity between the radio wave condition measured by the second measurement unit 102b and the radio wave condition transmitted from the in-vehicle device 10a. The in-vehicle device 10a according to the modification example of the embodiment corresponds to the second device, and the electronic key 10b according to the modification example of the embodiment corresponds to the first device. Further, the electronic key 10b according to the modification example of the embodiment corresponds to the door lock apparatus.

As described above, according to a modification example of the embodiment, the radio wave condition determination unit 108b of the electronic key 10b determines the similarity between the radio wave condition measured by the second measurement unit 102b and the radio wave condition transmitted from the in-vehicle device 10a, and the second lock control unit 110b outputs the unlock signal in a case where the similarity is high. With this, it is possible to control whether to lock or unlock the door according to asimilarity between radio wave conditions on the electronic key 10b side.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A door lock control system comprising:
a first device comprising:
a first transmitter;
a first receiver; and
a first controller configured to:
measure first signal strengths of radio signals received from a plurality of surrounding devices by the first receiver; and
control the first transmitter to transmit the measured first signal strengths to a second device; and
the second device comprising:
a second receiver; and
a second controller configured to:
measure second signal strengths of radio signals received from a plurality of surrounding devices by the second receiver;
control the second receiver to receive the first signal strengths from the first device;
compare the first signal strengths with the second signal strengths; and
control a door lock based on the comparison of the first and the second signal strengths.

2. The door lock control system according to claim 1, wherein
the second device comprises a second transmitter,
the second controller is configured to control the second transmitter to transmit to the first device a signal for synchronizing the timing of measuring the first signal strengths and the timing of measuring the second signal strengths, and
the first and the second receiver concurrently measure the first and the second signal strengths according to the signal.

3. The door lock control system according to claim 2, wherein
the second controller is configured to
determine a degree of similarity of the first and the second signal strengths, and
control the door lock based on the determined degree of similarity.

4. The door lock control system according to claim 3, wherein
the first and the second controller are configured to measure the first and the second signal strengths a plurality of times, and
the second controller unlocks a door when the degree of similarity of the first and the second signal strengths is equal to or greater than a threshold for each measurement.

5. The door lock control system according to claim 4, wherein
the second controller determines the degree of similarity based on a number of surrounding devices transmitting the radio signals, the signal strengths of which are equal to or greater than a threshold when received by both the first and the second receiver.

6. The door lock control system according to claim 2, wherein
the second controller is configured to
encrypt a first authentication code, and
control the second transmitter to transmit the encrypted first authentication code to the first device.

7. The door lock control system according to claim 6, wherein
the first controller further comprises a first memory that stores the first authentication code, and
the first controller is configured to:
decrypt the encrypted first authentication code received from the second device;
compare the decrypted first authentication code with the first authentication code stored in the first memory;
encrypt a second authentication code when the decrypted first authentication code and the stored first authentication code are identical; and
control the first transmitter to transmit the encrypted second authentication code to the second device.

8. The door lock control system according to claim 7, wherein
the second controller further comprises a second memory that stores the second authentication code, and
the second controller is configured to:
decrypt the encrypted second authentication code received from the first device;
compare the decrypted second authentication code with the second authentication code stored in the second memory; and
generate the signal for synchronizing the timing of measuring the first signal strengths and the timing of measuring the second signal strengths when the decrypted second authentication code and the stored second authentication code are identical.

9. The door lock control system according to claim 8, wherein
the second controller is configured to generate the signal indicating a time to start measuring the first and the second signal strengths.

10. The door lock control system according to claim 1, wherein
the first device is an electronic key, and
the second device is a device installed in a car or a mailbox.

11. A method carried out in a door lock control system with a first and a second device, the method comprising:
measure in the first device first signal strengths of radio signals received from a plurality of surrounding devices by the first device;
measure in the second device second signal strengths of radio signals received from a plurality of surrounding devices by the second device;
transmitting the measured first signal strengths from the first device to the second device;
comparing in the second device the first signal strengths with the second signal strengths; and
controlling a door lock based on the comparison of the first and the second signal strengths.

12. The method according to claim 11, further comprising:
transmitting from the second device to the first device a signal for synchronizing the timing of measuring the first signal strengths and the timing of measuring the second signal strengths, wherein
the first and the second signal strengths are concurrently measured according to the signal.

13. The method according to claim 12, further comprising:
determining in the second device a degree of similarity of the first and the second signal strengths, wherein
the door lock is controlled based on the determined degree of similarity.

14. The method according to claim 13, wherein
the first and the second signal strengths are measured a plurality of times, and
a door is unlocked when the degree of similarity of the first and the second signal strengths is equal to or greater than a threshold for each measurement.

15. The method according to claim 14, wherein
said determining comprises determining the degree of similarity based on a number of surrounding devices transmitting the radio signals, the signal strengths of which are equal to or greater than a threshold when received by both the first and the second device.

16. The method according to claim 12, further comprising:
encrypting in the second device a first authentication code, and
transmitting the encrypted first authentication code from the second device to the first device.

17. The method according to claim 16, further comprising:
decrypting in the first device the encrypted first authentication code received from the second device;
comparing the decrypted first authentication code with the first authentication code stored in the first device in advance;
encrypting a second authentication code when the decrypted first authentication code and the stored first authentication code are identical; and
transmitting the encrypted second authentication code from the first device to the second device.

18. The method according to claim 17, further comprising:
decrypting in the second device the encrypted second authentication code received from the first device;
comparing the decrypted second authentication code with the second authentication code stored in the second device in advance; and
generating in the second device the signal for synchronizing the timing of measuring the first signal strengths and the timing of measuring the second signal strengths when the decrypted second authentication code and the stored second authentication code are identical.

19. The method according to claim 18, wherein
the generated signal indicates a time to start measuring the first and the second signal strengths.

20. A door lock device comprising:
a receiver; and
a controller configured to:
measure signal strengths of radio signals received from a plurality of surrounding devices by the receiver;
control the receiver to receive from a remote device signal strengths of radio signals received from a plurality of surrounding devices by the remote device;
compare the signal strengths received from the remote device with the measured signal strengths; and
control a door lock based on the comparison of the received and the measured signal strengths.
